(19) United States
(12) Patent Application Publication
(10) Pub. No.: US 2011/0048895 A1
(43) Pub. Date: Mar. 3, 2011

(54) APPARATUS FOR SEPARATING FLAT OBJECTS BY WAY OF TWO LATERALLY OFFSET SEPARATORS

(75) Inventors: HOLGER SCHERERZ, REHFELDE (DE); MICHAEL SCHWARZBAUER, KONSTANZ (DE); FRANK VOSS, BERLIN (DE)

(73) Assignee: SIEMENS AKTIENGESELLSCHAFT, MUENCHEN (DE)

(21) Appl. No.: 12/869,853

(22) Filed: Aug. 27, 2010

(30) Foreign Application Priority Data
Aug. 27, 2009 (DE) 10 2009 039 067.7

(51) Int. Cl. B07C 1/02; B65G 37/00

(52) U.S. Cl. 198/463.1

(57) ABSTRACT

An apparatus for singulating flat items has a first separator and a second separator. The two separators are connected in series. The apparatus is configured in such a way that each object to be separated first of all runs through the first separator and then through the second separator. Each separator is configured for extending a plurality of objects, which partially overlap, in each case in a perpendicular extending plane and separating them as a result. A lateral offset is set between the two separators. As a result, a spacing also occurs between the two extending planes.

### CROSS-REFERENCE TO RELATED APPLICATION

This application claims the priority, under 35 U.S.C. §119, of German patent application DE 10 2009 039 067.7, filed Aug. 27, 2009; the prior application is herewith incorporated by reference in its entirety.

### BACKGROUND OF THE INVENTION

### Field of the Invention

The invention relates to an apparatus for separating flat objects, in particular flat mail items.

An apparatus of the generic type is described in U.S. Pat. No. 6,536,756 and its counterpart European published patent application EP 1090862 A1.

There, there is described an apparatus and a method for separating, transporting and orienting flat mail items. A feed device (“input feed structure 17”) having an endless conveyor belt 18 draws upright mail items from a stack 11, cf. FIG. 1. A first separator (“first document singulating apparatus 23”) separates mail items which overlap partially. The first separator 23 has a transport element and a retaining element in the opposite direction, cf. FIG. 2. An advancing unit (“take away unit 25”) having two advancing rollers (“drive roller 29, idler roller 27”) is attached downstream of the first separator 23. The mail items run through the first separator and subsequently the advancing unit 25 and then reach an aligning apparatus (“aligner station 31”) which has a free-running section in the form of a U-shaped transport channel with two rigid side walls 33, 35. While a mail item is being transported along the aligning apparatus 31, the mail item passes an arrangement having a plurality of sensors 105. Each sensor 105 is, for example, a light barrier which is interrupted by a mail item in the aligning apparatus 31. The aligning apparatus 31 is adjoined by a second separator (“second document singulating apparatus 39”) which likewise has a transport element and a retaining element. The second separator is followed by a second advancing device 41 having two advancing rollers 27, 29.

In one refinement of U.S. Pat. No. 6,536,756 and EP 1090862 A2 (FIG. 6), a “singulator sensor 105c” is situated at the level of the second separator 39, and a “take away sensor 105d” is situated at the level of the second advancing unit 41. The signals from the light barriers 105c, 105d are used to stop or restart a feeding conveyor belt 42a in the aligning apparatus 31.

U.S. Pat. No. 6,550,764 B2 also describes an apparatus having two separators which are connected in series, an aligning apparatus and a plurality of light barriers 201 to 231. The light barriers 201 to 231 are interrupted by a mail item. In start/stop operation, the first separator is operated as a function of light barrier signals.

An apparatus of that type having a plurality of separators is also described in the commonly assigned patent application publication US 2009/189332 A1 and its counterpart German patent DE 10 2004 037 422 B3.

Commonly assigned U.S. Pat. No. 7,537,207 B2 and its corresponding German patent DE 103 50 623 B3 describe a separating apparatus having a plurality of separating stages. Each separating stage has in each case one driven transport element. Moreover, the separating apparatus has a continuous retaining element. The respective transport element of each separating stage is moved relative to the continuous retaining element. As a result, each separating stage extends objects which overlap partially.

German published patent application DE 19608939 A1 describes a device for separating and accelerating printed products. Flat objects reach a separating assembly as overlapping stream and lie here on an endless conveyor belt (feed belt 1 of FIG. 3). A guide plate 18 which is situated above the feed belt 1 retains individual flat objects. A pair of roller shafts 4a, 4b pulls the respectively lowermost flat object off from the conveyor belt 1. The rollers 4a, 4b rotate in opposite rotational directions at the same speed and more rapidly than the feed belt 1 feeds flat objects. The rollers 4a, 4b temporarily clamp a flat object between them. A belt system 11 transports the flat object away which has been pulled off. The endless conveyor belts 1, 11 are arranged at different heights, namely the conveyor belt 11 is arranged somewhat lower than the conveyor belt 1. A flat object which is pulled off from the conveyor belt 1 is temporarily guided around in each case one segment of the circumferential face of the rollers 4a, 4b, cf. FIG. 3.

### SUMMARY OF THE INVENTION

It is accordingly an object of the invention to provide an apparatus and a method for separating flat objects by way of laterally offset separators which overcome the disadvantages of the heretofore-known devices and methods of this general type and which provides for separation at a lesser fault rate than the prior art apparatus and methods.

With the foregoing and other objects in view there is provided, in accordance with the invention, an apparatus for separating flat objects, each of the objects extending in an object plane, the apparatus comprising:

a first separator having a driving element and a retaining element; and

a second separator having a driving element and a retaining element;

the first and second separators being connected in series and each object first running through the first separator and then through the second separator, wherein each object is transported through between the respective the driving element and the respective the retaining element of each the first and second separator, and

each of the first and second separators being configured:
to move the respective the driving element relative to the respective the retaining element; and
to pull apart a plurality of objects that overlap one another at least partially in a respective extending plane parallel to the object planes, and to thereby singulate the plurality of objects;

wherein the two extending planes are perpendicular to a horizontal; and

the first and second separators being disposed with a lateral offset therebetween, resulting in a spacing distance between the two extending planes.

In other words, the apparatus according to the invention comprises a first separator and a second separator. Each separator has in each case a driving element and a retaining element. The two separators are connected in series. The apparatus is configured in such a way that each object to be separated first of all runs through the first and then the second separator.

Each separator is configured to move the driving element relative to the retaining element. Each object to be separated is transported through between the driving element and the retaining element. Each separator is able to extend a plurality of objects, which overlap at least partially, in in each case one extending plane and to separate them as a result. The two extending planes both stand perpendicularly on the horizontal.

A lateral offset occurs between the two separators. As a result, a spacing also occurs between the two extending planes.

According to the solution, the two extending planes therefore do not coincide, but rather differ from one another.

For the following reason, in particular, the apparatus according to the solution leads to improved separation with a relatively low error rate:

If two partially overlapping objects are transported from the first separator to the second separator, the objects are deflected from the first extending plane into the second extending plane, to be precise one after another. First of all, the front edge of the leading object is gripped by the second separator, while the rear edge of the following object is still being gripped by the first separator. As a result, the spacings between the front edges and/or the rear edges of the objects can change, or a spacing occurs between the objects, as viewed perpendicularly onto the extending planes. This brings it about that the second separator can separate the objects more easily.

The apparatus according to the invention brings about improved separation in comparison with an apparatus, in which the two separators separate in the same extending plane. However, the apparatus according to the solution requires no additional apparatus outlay at all and only a small amount of additional space.

In order to turn an already existing apparatus with two separators, the extending planes of which coincide, into an apparatus according to the solution, it is sufficient to displace one of the two separators laterally, that is to say perpendicularly with respect to the extending plane. It is also possible to rotate one separator and therefore its extending plane about a perpendicular rotational axis. An already existing two-stage separating apparatus can therefore be converted with low outlay into an apparatus according to the invention.

According to the solution, both extending planes stand perpendicularly on the horizontal. The two separators are either arranged in such a way that the two extending planes are arranged parallel to one another, or in such a way that the two extending planes are at an angle to one another and intersect in a straight line. This straight line then stands perpendicularly on the horizontal.

The perpendicular extending planes lead to the apparatus according to the solution separating upright objects. This in turn brings it about that particles which are abraded from the driver element or from the retaining element or other dirt particles fall downward past the perpendicularly standing objects and are transported together with the objects to a following processing device or continue to adhere to the objects. Moreover, gravity brings it about that the objects to be separated can be aligned at their lower edges on account of gravity.

The design of each separator with a driver element and a retaining element leads to an improved separating action of the separator over other designs.

The two separators are preferably spaced apart from one another, as viewed in the transport direction. However, the spacing is so small that every object to be separated which runs through the apparatus with the two separators is held and gripped at every instant by the first separator or by the second separator or by both separators. This refinement makes it possible to grip every object at every time, even if the first separator is stopped because the second separator is currently eliminating a double draw-off. Furthermore, it can be established for every instant where which object is situated.

In one refinement, the separators are arranged in such a way that the two extending planes extend parallel to one another and are at the same spacing from one another over the entire length of the two separators. This refinement with parallel extending planes leads to the lowest risk of objects being bent or damaged in another way during the transport from the first to the second separator.

In another refinement, both extending planes are rotated relative to one another and abut one another in an imaginary straight line. This refinement with rotated extending planes often leads to improved separating results because, during the transport from the first separator to the second separator, an object is additionally rotated about a rotational axis parallel to said straight line. The line of intersection extends, for example, horizontally or perpendicularly.

In one refinement, the second separator has at least one endless conveyor belt. For example, the endless conveyor belts belong to a transport element, and said endless conveyor belts are driven. The transport element is moved relative to a retaining element, which brings about the separation. The endless conveyor belts which are present in any case additionally bring it about that the endless conveyor belts deflect an object from the first into the second extending plane.

In another refinement, the second separator has at least one stationary deflection element. For example, the stationary deflection elements belong to a retaining element of the second separator. A transport element of the second separator is moved relative to the retaining element, which brings about the separation. The retaining element which is present in any case is arranged in such a way that it additionally deflects an object from the first to the second extending plane.

Flat objects are preferably deflected by a stationary deflection element from the first into the second extending plane. Said stationary deflection element lies in the first extending plane and does not have any movable parts, does not use any energy, requires virtually no maintenance and is subject to only low wear.

In another refinement, at least one endless conveyor belt deflects the objects from the first into the second extending plane. The endless conveyor belt preferably lies in the first extending plane and adjoins the second extending plane. An object in the first extending plane which is transported to the second separator butts with its front edge against the endless conveyor belt. The endless conveyor belt deflects the object.

This endless conveyor belt preferably belongs to a transport element of the second separator. Said transport element is moved relative to a retaining element of the second separator, as a result of which the second separator extends objects. The at least one endless conveyor belt of the second separator is present in any case, with the result that this refinement of the apparatus according to the solution does not require any additional elements.

The path which an object covers during the transport between the transport element and the retaining element of the second separator, as viewed in the transport direction, is preferably longer than the longest object. The length of this path can be fixed by a corresponding design of the second separator.

This refinement ensures that the second separator is long enough to make it possible that, during the transport of objects through the second separator, an overlap is detected in good time and the second separator can eliminate this overlap (double draw-off). A double draw-off of this type occurs if the first separator has not separated said objects and the objects are therefore transported in an overlapping manner to the second separator. A corresponding design of the second separator can fix how long this transport path in the second separator is.

The second separator is preferably configured in such a way that this path is at least 20% longer than the length of the longest object, as seen in the transport direction.

Other features which are considered as characteristic for the invention are set forth in the appended claims.

Although the invention is illustrated and described herein as embodied in an apparatus and method for separating flat objects by means of two laterally offset separators, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a plan view of an exemplary embodiment of the apparatus according to the invention;

FIG. 2 is a section through the first separator taken along the plane II-II in FIG. 1;

FIG. 3 shows the first separator of the apparatus from FIG. 1 in a detailed view with a measuring arrangement; and

FIG. 4 shows the detailed view from FIG. 3 with a measuring arrangement that has a measurement lever.

### DETAILED DESCRIPTION OF THE INVENTION

In the exemplary embodiment, the apparatus according to the solution is used to separate flat mail items. Each mail item extends in an object plane. The mail items are transported to the apparatus in a random arrangement.

The mail items are processed by a sorting system with the aim of sorting the mail items as a function of their respective delivery address. For this purpose, it is necessary to decipher the delivery address of each mail item and to eject the mail item as a function of the delivery address into a sorting terminal of the sorting system. The apparatus according to the solution of the exemplary embodiment is used to separate the mail items in such a way that the mail items can be aligned and oriented afterward, the respective delivery address can subsequently be deciphered and the mail items can be ejected correctly.

The apparatus has two separators which are connected in series. Each separator comprises:

a transport element (driving element),

a drive for the transport element,

a retaining element,

an advancing element and

a drive for the advancing element.

The same motor can drive the drives of both transport elements and of both advancing elements. However, the transport element and the advancing element of each separator preferably have in each case a dedicated drive, in order that each separator can be actuated separately and can transport or stop mail items separately.

The mail items are transported through between the transport element and the retaining element of the first separator, are then transported by the advancing element of the first separator, are subsequently transported through between the transport element and the retaining element of the second separator, and finally are transported by the advancing element of the second separator.

During the transport, both the transport element and the retaining element of each separator bear flatly against the mail item, that is to say over the entire length of the mail item or a considerable part of the mail item length. This achieves improved separation than when only two rollers are in contact.

Both each transport element and each retaining element have a nonslip surface, with the result that in each case a sufficiently great coefficient of friction occurs between a mail item and the transport element and between the mail item and the retaining element, to be precise both for the static friction and for the sliding friction. The term “coefficient of friction” is defined, for example, in Dubbel, Taschenbuch für den Maschinenbau [Pocket book for mechanical engineering], 18th edition, section B15. The frictional force is equal to the product of transverse force and coefficient of friction.

The coefficient of friction between a transport element and a mail item is greater than the coefficient of friction between a retaining element and the mail item. The coefficient of friction between the retaining element and the mail item is greater than the coefficient of friction between two mail items which adhere to one another.

In the exemplary embodiment, each transport element comprises a plurality of endless conveyor belts which lie above one another, are guided around at least two rollers and are called “driving conveyor belts” in the following text. Each of said rollers is mounted rotatably on a perpendicular shaft or a perpendicular axle. Precisely one roller, about which a driving conveyor belt of a transport element is guided, is preferably driven, and the other rollers are configured as running rollers. In the exemplary embodiment, all the driving conveyor belts of a transport element are guided around the same three rollers. A slot occurs between in each case two driving conveyor belts which lie above one another.

In the exemplary embodiment, the retaining element comprises a plurality of stationary components. Each of said components comprises a straight element. Said straight element bears flatly against a mail item. The stationary components of a retaining element are arranged above one another. In order to hold the components in position, the stationary components which lie above one another rest on a rake of a belt support. Said belt support is mounted in a stationary manner, for example on a separator base plate. Furthermore, each stationary component comprises a bent deflection component.

In another refinement, each retaining element also in each case comprises at least one endless conveyor belt which is called a “retaining conveyor belt” in the following text. Said endless conveyor belt is guided around running rollers which are likewise mounted on perpendicular shafts.

In one refinement, each driving conveyor belt, that is to say each endless conveyor belt of a transport element, has projections which engage into corresponding cutouts of the retaining element which lies opposite, for example into the slot between two stationary components which lie above one another. Said projections and cutouts extend in the longitudinal direction along the transport direction and are configured, for example, as horizontal continuous lines. It is also possible that the retaining element has projections which engage into cutouts of the transport element.

In the exemplary embodiment, the transport element of each separator comprises a plurality of driving conveyor belts which lie above one another and engage into slots between in each case two stationary components, which lie above one another, of the corresponding retaining element, without the driving conveyor belts and stationary components coming into contact with one another. As a result, a mail item which is transported through between the transport element and the retaining element is temporarily given a contour in the form of a sinuous line, as viewed in the transport direction. The driving conveyor belts and stationary retaining components form two sawtooth lines.

In one refinement, each separator additionally comprises an intake apparatus. Said intake apparatus sucks in air. The air flows through cutouts in each driving conveyor belt of the transport element and generates a vacuum. Said vacuum pulls an item (an individual mail item or a plurality of overlapping mail items) toward the driving conveyor belts and increases the transverse force and therefore the frictional force between each driving conveyor belt and the mail item, which frictional force acts on the mail item. It is also possible that the intake apparatus generates a vacuum between the retaining element and the mail item.

In the exemplary embodiment, a sequence of cutouts in the form of holes is made in each driving conveyor belt. Said cutouts preferably extend over the entire length of a driving conveyor belt. An intake apparatus which bears against the driving conveyor belts then sucks air through said cutouts when the cutouts are guided past an intake chamber of the intake apparatus. No air is sucked in through the slot between two adjacent driving conveyor belts.

The transport rollers of the advancing elements are driven in opposite rotational directions.

The mail items are transported in an upright manner to the first separator. Each flat mail item is therefore standing on one edge. An underfloor conveyor belt transports the upright mail items in a transport direction which lies parallel to the object planes or is perpendicular on said object planes.

In one refinement, a stack of flat mail items is transported perpendicularly with respect to their object planes toward the first separator. In another refinement, the mail items are transported in a direction parallel to their object planes to the first separator, a plurality of mail items partially overlapping as a rule. Here, the “overlap” is to be understood as being in a direction perpendicular with respect to the object planes of the flat mail items.

The mail items, also those which overlap, pass between the transport element and the retaining element of the first separator. The transport element of the first separator drives overlapping mail items. For example, the mail items adhere to the driving conveyor belts and are moved by the retaining element toward the first transport element.

The first separator extends overlapping mail items because the coefficient of friction between a mail item and the retaining element is greater than the coefficient of friction between two overlapping mail items. In order to bring this about, the transport element moves more quickly than the retaining element of the first separator, with the result that a relative speed of the transport element occurs relative to the retaining element. In the exemplary embodiment, the retaining element does not move at all. Preferably no slip occurs between the mail item and the transport element because the coefficient of friction and therefore the frictional force between a mail item and the transport element is even greater. The optionally generated vacuum reinforces this effect.

Each separator brings it about as a result that each separator extends flat upright mail items in a perpendicular extending plane. The respective object planes of the flat mail items are arranged parallel to said extending planes.

In the exemplary embodiment, furthermore, each separator has an advancing element with two driven transport rollers. The two transport rollers are rotated at the same rotary speed in different rotational directions. At every contact point, the two transport rollers bring about the same transport vector. Said two transport rollers have in each case one nonslip outer face and are seated on parallel and driven rollers. The advancing element is arranged downstream of the transport element and the retaining element of the separator.

In the exemplary embodiment, the transport rollers are sprung in such a way that compression springs press the two transport rollers against one another, but a mail item is capable of pressing the transport rollers apart from one another when the two transport rollers grip the mail item and advance it.

Furthermore, the first separator has the first advancing element with the two transport rollers, which first advancing element is arranged downstream of the transport element and the retaining element. A mail item is transported through between both transport rollers, both transport rollers gripping the mail item temporarily. As soon as the front edge of a mail item is gripped by the two transport rollers, the transport element and the retaining element are stopped. The transport rollers advance a mail item between the transport element and the retaining element. If said mail item overlaps partially with a following mail item, the transport rollers grip only the leading mail item, but not the following mail item. The following mail item is retained by the transport element and the retaining element. As soon as it is determined that the rear edge of the leading mail item has passed the transport rollers, at least the transport element is rotated again and transports the following mail item toward the transport rollers.

The first separator therefore operates in a start/stop mode. The transport element is continuously started and stopped again. In contrast, the transport rollers of the advancing element are rotated continuously.

A light barrier or another suitable sensor measures the events, namely that a front edge of a mail item has reached the two transport rollers of the first separator and that the rear edge has passed the transport rollers. The mail item interrupts the light beam which the transmitter of the light barrier has emitted.

An individual mail item which is transported by the transport element of the first separator drives the retaining element in rotation in one refinement. In another refinement, the retaining element remains stationary. In contrast, two overlapping mail items are extended by the interaction of the transport element and the retaining element.

The second separator preferably operates in the same way, as long as the second separator likewise operates in the separating mode.

The transport element of the second separator is preferably arranged on the other side of that transport path, over which the mail items are transported, than the transport element of the first separator. If, therefore, the transport element of the first separator is arranged to the left of the transport path as viewed in the transport direction, the transport element of the second separator is situated to the right of the transport path. Correspondingly, the retaining elements of the two separators are also attached on different sides of the transport path.

This refinement brings about improved separation. The following is namely possible: two mail items overlap partially before they reach the first separator. The leading mail item bears against the retaining element of the first separator, and the following mail item bears against the transport element of the first separator. The transport element is capable of transporting the following mail item forward relative to the leading mail item and bringing about separation as a result. However, it can occur that the following mail item which is pulled forward becomes hooked in a tab or a viewing window or a similar component of the leading mail item and cannot be advanced further, with the result that the first separator is not capable of separating these two mail items.

In this constellation, in contrast, the second separator will pull the leading mail item forward relative to the following mail item and bring about the separation as a result. The hooking between the two mail items is released automatically by virtue of the fact that the second separator introduces forces on another side of the item which comprises the hooked mail items than the first separator.

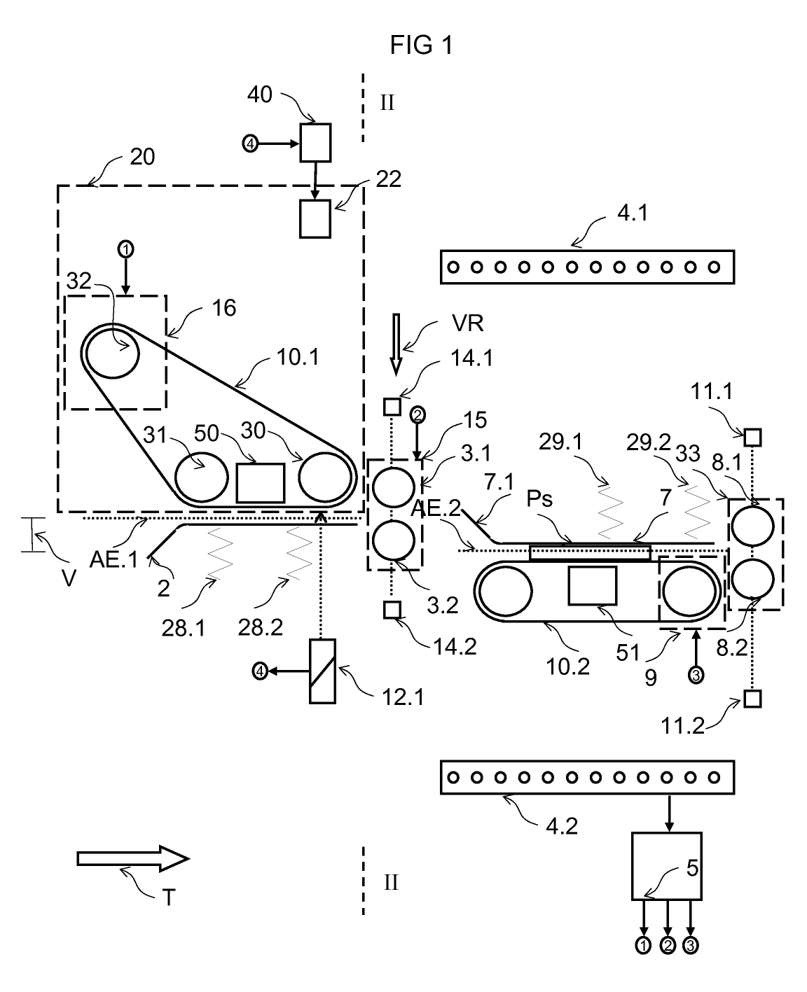

Referring now, particularly, to FIG. 1 there are shown the two separators by way of example. The first separator comprises the driven first transport element 10.1, which comprises a plurality of driving conveyor belts which lie above one another, and the first retaining element 2. Two compression springs 28.1, 28.2 press the first retaining element 2 against the driving conveyor belts of the first transport element 10.1 to such an extent that only a predefined minimum spacing remains between the transport element 10.1 and the retaining element 2.

Furthermore, FIG. 1 shows
the first advancing element 3 with the two transport rollers 3.1, 3.2 down-stream of the first transport element 10.1 and the first retaining element 2,
a light barrier 14 with a transmitter 14.1 and a receiver 14.2, and
a control device 5.

A mail item which is transported by the first transport element 10.1 is gripped by the transport rollers 3.1, 3.2 and is transported to the second separator. The light barrier 14 measures when the front edge of the mail item has reached the transport rollers 3.1, 3.2. The transmitter 14.1 preferably emits a light beam which is situated in that plane which is defined by the two center axes of the transport rollers 3.1, 3.2.

A drive motor 15 rotates the transport roller 3.1 or both transport rollers 3.1, 3.2 of the first advancing element 3. In one refinement, the transport rollers 3.1, 3.2 rotate equally as quickly as the driving conveyor belts of the first transport element 10.1.

The control device 5 actuates the drive motors for the transport elements and advancing elements of the two separators and brings about this start/stop mode as a result. The light barriers transmit signals to said control device 5, and the control device 5 processes said signals.

Furthermore, FIG. 1 shows the two extending planes AE.1, AE.2. A lateral offset V occurs between said two extending planes AE.1, AE.2 in the exemplary embodiment. In the exemplary embodiment, the two perpendicular extending planes AE.1, AE.2 are arranged parallel to one another, with the result that the lateral offset V remains constant over the entire extent of the extending planes AE.1, AE.2.

In the exemplary embodiment, the driving conveyor belts of the first transport element 10.1 are guided around the three rollers 30, 31 and 32. A drive motor 16 rotates the roller 32 and therefore the first transport element 10.1. The control device 5 is capable of switching both drive motors 15, 16 on and off again.

The first separator comprises, furthermore, an intake chamber 50. Each driving conveyor belt of the first transport element 10.1 is guided past an opening of said intake chamber 50. The intake chamber 50 sucks in air through said opening and through cutouts in the driving conveyor belts of the transport element 10.1.

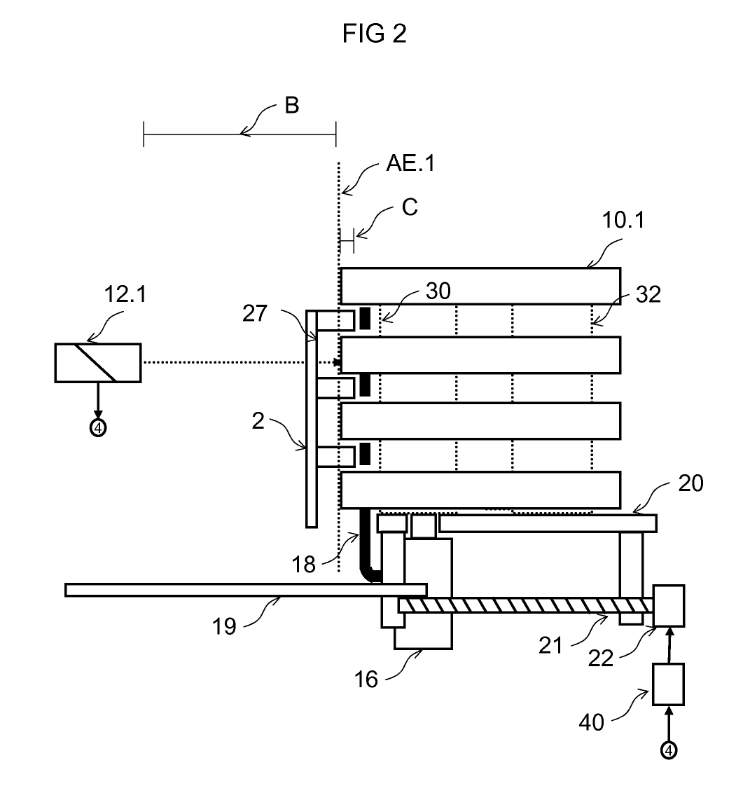

FIG. 2 shows in detail and in the plane II-II from FIG. 1 that the first transport element 10.1 comprises a plurality of individual driving conveyor belts which lie above one another. The first retaining element 2 has a plurality of stationary components which are arranged above one another and between which the rake 27 of a belt support 18 lies. The individual components of the first retaining element 2 run over in each case one projection of the rake 27. The first retaining element 2 has projections which bear against a mail item.

The driving conveyor belts of the first transport element 10.1 protrude with a spacing C beyond the projections of the first retaining element 2. The first retaining element 2 is mounted on the separator base plate 19. In an embodiment which has already been shown, the first retaining element 2 comprises a plurality of stationary components which are arranged above one another and lie on a rake 27 of a belt support 18. The belt support 18 is mounted in a stationary manner on the separator base plate 19.

The three rollers 30, 31, 32, around which the driving conveyor belts of the first transport element 10.1 are guided, are mounted on a mounting plate 20. The mounting plate 20 is preferably mounted movably in such a way that an actuating drive 22 is capable of displacing the mounting plate 20 in a displacement direction VR perpendicularly with respect to the transport direction T and perpendicularly with respect to the transport path, cf. FIG. 1. In contrast, the separator base plate 19 is mounted in a stationary manner. Because the mounting plate 20 can be displaced relative to the separator base plate 19, the spacing between the first transport element 10.1 and the first retaining element 2 can be changed, as a result of which wear of the first transport element 10.1 can be compensated for.

The actuating drive 22 preferably rotates at least two toothed belts, and said toothed belts rotate at least two spindles. Said spindles engage into corresponding fastening elements of the mounting plate 20. A rotation of the spindles 21 causes the mounting plate 20 to perform a linear movement, to be precise perpendicularly with respect to the transport direction T, in which the first separator transports mail items. The actuating drive 22 is actuated by the control device 5 and is capable of rotating the spindles 21.

The second separator comprises the following components which are shown in FIG. 1:
a driven transport element 10.2 (the second transport element) in the form of a plurality of endless conveyor belts which lie above one another,
a drive motor 9 for the second transport element 10.2,
a retaining element 7 (the second retaining element) in the form of a plurality of stationary components which are arranged above one another,
an advancing element 8 having two driven transport rollers 8.1, 8.2,
a drive motor 33 for the transport rollers 8.1, 8.2,
a light barrier 11 having a transmitter 11.1 and a receiver 11.2, and
an intake chamber 51.

According to the solution, the path which a mail item covers during transport between the transport element and the retaining element of the second separator, as viewed in the transport direction, is longer than a mail item of maximum length. FIG. 1 shows a mail item Ps of maximum length.

An arrangement having a plurality of compression springs 29.1, 29.2 presses the second retaining element 7 against the driven second transport element 10.2.

The two transport rollers 8.1, 8.2 of the second advancing element 8 advance the separated mail items between the second transport element 10.2 and the second retaining element 7.

In the exemplary embodiment, the transport element 10.1 of the first separator is arranged to the left of the conveying path as viewed in the transport direction T, and the transport element 10.2 of the second separator is arranged to the right of the conveying path.

In the exemplary embodiment, the second separator can be switched to and fro between two modes, namely a separating mode and a transport mode.

In the exemplary embodiment, the second separator has a light barrier 11 with a transmitter 11.1 and a receiver 11.2. Said light barrier 11 determines whether the front edge of an “item” has reached the transport rollers 8.1, 8.2. The term “item” denotes both an individual mail item and a plurality of mail items which overlap partially or totally.

In the separating mode, the second separator operates in exactly the same way as the first separator in the start/stop mode. The second transport element 10.2 transports an item as far as the transport rollers 8.1, 8.2 of the second advancing element 8. As soon as the front edge of this item has reached the transport rollers 8.1, 8.2, the second transport element 10.2 is stopped. The transport rollers 8.1, 8.2 which continue to be driven advance the leading mail item between the second transport element 10.2 and the second retaining element 7. The second transport element 10.2 and the second retaining element 7 retain a following mail item. As a result, overlapping mail items are extended and separated from one another.

In the transport mode, the second separator transports a mail item without being stopped and without exerting a separating action. The second transport element 10.2 therefore transports an item further even if its front edge has reached the transport rollers 8.1, 8.2.

The second separator is operated in the transport mode until it is determined that the first separator has not completely separated two overlapping mail items. Only then is the second separator switched over into the separating mode and separates said overlapping mail items. As soon as all of these separated mail items have completely left the second separator, the second separator is switched over again into the transport mode.

The second separator is then switched over from the transport mode into the separating mode if it is determined that an item in the second separator comprises a plurality of overlapping mail items, and the front edge of said item, that is to say the front edge of the frontmost (or: forward-most) mail item, has reached the transport rollers 8.1, 8.2. This reaching of the transport rollers 8.1, 8.2 is determined by the light barrier 11. The second separator is preferably changed over precisely when said transport rollers 8.1, 8.2 are reached. The frontmost mail item is transported further to such an extent that the transport rollers 8.1, 8.2 grip said frontmost mail item reliably.

The second separator is switched over from the transport mode into the separating mode by virtue of the fact that the control device 5 stops the drive motor 9 of the second transport element 10.2. The transport rollers 8.1, 8.2 then advance the leading mail item between the second transport element 10.2 and the second retaining element 7 which are both stopped. The following mail item is retained by the second transport element 10.2 and by the second retaining element 7.

It is preferably prevented that further mail items are transported into the second separator, as long as the second separator eliminates the detected double draw-off. This is prevented by the entire first separator additionally being stopped temporarily. The control device 5 therefore stops the drive motors 16 (for the first transport element 10.1) and 15 (for the first advancing element 3). This stopping of the first separator is preferably carried out at the same time as the step of switching over the second separator into the separating mode. Only when all the previously overlapping mail items have completely left the second separator does the control device 5 restart the first separator. The control device 5 preferably switches over the second separator again into the transport mode at the same time.

A light barrier determines that instant, at which the rear edge of the leading mail item which has now been separated has passed said light barrier and therefore a gap occurs between the leading and the now following mail item. Said light barrier can be the light barrier 1 or a light barrier of the light barrier arrangement 4 described further below or a further light barrier which is arranged downstream of the light barrier 14. Discovering the gap triggers the steps of the control device 5 switching over the second separator again into the transport mode and switching on the drive motor 9 again. The second transport element 10.2 transports mail items continuously to the transport rollers 8.1, 8.2. Moreover, the first separator starts up its start/stop mode again. For this purpose, the control device 5 restarts the drive motors 16 (for the first transport element 10.1) and 15 (for the first advancing element 3).

The second separator therefore operates in the start/stop mode only when a double draw-off is determined, and otherwise operates in a continuous transport mode. As a result, a considerably higher throughput is achieved. Moreover, the wear-susceptible start/stop mode is reduced to the required minimum.

In order to decide automatically whether an item in the second separator is an individual mail item or comprises a plurality of partially overlapping mail items, the apparatus comprises, furthermore, a light barrier arrangement 4. Said light barrier arrangement 4 has a transmitter line 4.1 with a plurality of transmitters and a receiver line 4.2 with a plurality of receivers which are arranged behind one another.

In one refinement, the transmitter line 4.1 and the receiver line 4.2 extend over the length of the entire first separator and the entire second separator. In the minimum refinement, the light barrier arrangement 4 monitors at least the second transport element 10.2 and the second retaining element 7.

The transmitter line 4.1 comprises at least one row with a multiplicity of transmitters which emit parallel light beams. Correspondingly, the receiver line 4.2 comprises at least one row with a multiplicity of receivers which receive the light beams from the transmitters. It is possible that the transmitter line 4.1 and the receiver line 4.2 in each case comprise a plurality of individual lines which are arranged above one another. As a result, the light barrier arrangement 4 is capable of detecting different mail items of different heights.

Each mail item interrupts each light beam from a transmitter if said light beam strikes the mail item. A light beam from a transmitter, which light beam is not interrupted by a mail item, strikes the corresponding receiver.

A sequence of measuring instants is predefined. The temporal interval between two measuring instants which follow one another is varied, for example, in an inversely proportional manner to the transport speed of the second separator, or remains constant. The temporal interval is so small that a plurality of measuring instants fall within each time period, in which a mail item runs through the second separator.

At every measuring instant, each receiver of the receiver line 4.2 supplies precisely one of the two possible signals “light beam has struck receiver” or “no light beam has struck”, that is to say light beam interrupted by a mail item. As a result, a sequence of items in the second separator is discovered for each measuring instant, an item comprising an individual mail item or a plurality of at least partially overlapping mail items. In each case one gap, through which at least one light beam passes, is situated between in each case two items which follow one another.

Each item interrupts at least one light beam. The spacing between two gaps which follow one another is equal to the length of the transported item between said two gaps. This gap spacing is calculated approximately as the spacing between the two receivers of the receiver line 4.2 which are struck by in each case one light beam.

The receiver line 4.2 transmits measured signals to the control device 5. The control device 5 evaluates said measured signals and decides whether an item which comprises a plurality of overlapping mail items is transported in the second separator or not.

While an item which comprises a plurality of mail items is transported through the second separator, an additional gap can occur in said item, namely because two previously overlapping mail items of the item are extended by an interaction of the second transport element 10.2 and the second retaining element 7. This extension is brought about by the second transport element 10.2 and the second retaining element 7 being actuated in such a way that a relative speed occurs between said elements 10.2 and 7 and the second transport element 10.2 is moved more quickly than the second retaining element 7.

Said light barrier arrangement 4 therefore measures the length of the same item at at least two measuring instants, while the second separator is situated in the transport mode and the second transport element 10.2 transports said item toward the transport rollers 8.1, 8.2 of the second advancing element 8.

A relative speed preferably occurs between the second transport element 10.2 and the second retaining element 7. For example, the second retaining element 7 is not driven, but rather is driven in rotation by mail items, or comprises stationary components. As a result, a plurality of overlapping mail items are extended, and an item which comprises a plurality of mail items changes its length, while it is transported through the second separator. If the length of the item varies during the transport, the item comprises a plurality of overlapping mail items.

In this case, the second separator is switched over into the separation mode, as soon as the front edge of the item reaches the light barrier 11. Said front edge is formed by the front edge of the leading mail item of the item. The retaining element 7 and the transport element 10.2 of the second separator retain every following mail item of the item.

Instead of a light barrier arrangement 4, the second separator can also have a camera which produces a side image of the item. The contour of the item in the image is evaluated. If said contour exhibits a plurality of rectangles, the item comprises a plurality of mail items. This refinement spares the necessity to generate a relative speed between the second transport element 10.2 and the second retaining element 7.

The transport path which is run through by the mail items preferably comprises two straight sections and a curved transition region. The first straight section is formed by the first transport element 10.1 and the first retaining element 2 of the first separator, and the second straight section is formed by the second transport element 10.2 and the second retaining element 7 of the second separator. The second straight section is offset laterally relative to the first section, with the result that the transition region is curved, to be precise is preferably curved in an S-shape. FIG. 1 shows this lateral offset V in exaggerated form.

The first separator is capable of extending objects in a first extending plane. The second separator is capable of extending objects in a second extending plane. In the exemplary embodiment, said two extending planes are arranged parallel to one another and are at a spacing V from one another. An element 7.1 acts as diverting element. If an object is transported from the first separator to the second separator, the diverting element 7.1 diverts said object from the first into the second extending plane. The diverting element 7.1 preferably comprises a plurality of diverting components which lie above one another, here the curved components of the second retaining element 7.

In one modification, the two extending planes meet one another at an acute angle. As a result, the two extending planes intersect in a straight line. If a mail item is transported from the first separator to the second separator, the mail item is rotated about a rotational axis which lies parallel to said line of intersection. This rotation often additionally improves the separating action.

If two overlapping mail items run through said curved region, the front edge of the leading mail items is already gripped by the downstream second separator and the rear edge of the following mail item is still gripped by the upstream first separator. As a result, the spacings between the front edges and/or the rear edges can change, and a spacing and/or an offset occur/occurs between the two mail items. This brings about a situation where the mail items are separated more easily by the second separator.

In one preferred refinement, the wear of the driving conveyor belts of the transport elements 10.1, 10.2 and/or of the retaining elements 2, 7 is monitored, and at least one element is adjusted automatically. FIG. 1 to FIG. 4 illustrate this adjustment by way of example for the first transport element 10.1 of the first separator.

A distance sensor 12.1, 12.2, 12.3 continuously measures the spacing between itself and that surface of the first driving conveyor belt 10.1 which faces the mail items to be separated. The separating of mail items leads to particles being abraded from the facing surface of the conveyor belt 10.1 and, as a result, the spacing between the first transport element 10.1 and the first retaining element 7 being reduced. Correspondingly, the section C is reduced, by which the first transport element 10.1 protrudes out of the retaining element 2.

In order to compensate for this increase in spacing, the mounting plate 20 is displaced by way of the first transport element 10.1 transversely with respect to the transport direction in the displacement direction VR toward the first retaining element 2. As a result, the spacing between the first transport element 10.1 and the first retaining element 2 is changed. The actuating drive 22 rotates the spindles 21, with the result that a desired transmission ratio is brought about between the rotation of the actuating drive 22 and the displacement of the mounting plate 20. A regulator 40 actuates said actuating drive 22. Signals are transmitted from a distance sensor to the regulator 40. The regulator 40 uses these measured signals and a setpoint variable in order to calculate the actuating commands to the actuating drive 22.

In one refinement which is shown by FIG. 2, a distance sensor 12.1 measures the spacing B between itself and that surface of the driving conveyor belts of the first transport element 10.1 which faces the first retaining element 2 and therefore the mail items to be separated. For example, the distance sensor 12.1 transmits a laser beam through a cutout in the first retaining element 2 perpendicularly onto the surface of the first transport element 10.1. The wear of the driving conveyor belts of the first transport element 10.1 increases the spacing B. In order to compensate for this increase in spacing, the mounting plate 20 is moved downward in FIG. 1 and to the left in FIG. 2 toward the first retaining element 2 and therefore toward the distance sensor 12.1.

In the refinement which is shown in FIG. 2, a distance sensor 12.1 therefore measures the spacing B directly. The mounting plate 20 is displaced such that said spacing remains constant.

One problem of this refinement is that a spacing measurement is made more difficult or is even impossible if a mail item is situated between the first transport element 10.1 and the first retaining element 2.

In an alternative refinement, it is made possible to permanently measure a dimension for the wear of the first driving conveyor belt 10.1, even if a mail item between the first driving conveyor belt 10.1 and the first retaining element 2 prevents a direct measurement of the spacing B. For this purpose, a spacing sensor 12.2 is used. For example, the spacing sensor 12.2 measures the spacing D between the surface of the first driving conveyor belt 10.1 and the distance sensor 12.2, to be precise in a region, in which the first driving conveyor belts of the first transport element 10.1 are guided around the roller 32 and which region does not lie opposite the first retaining element 2.

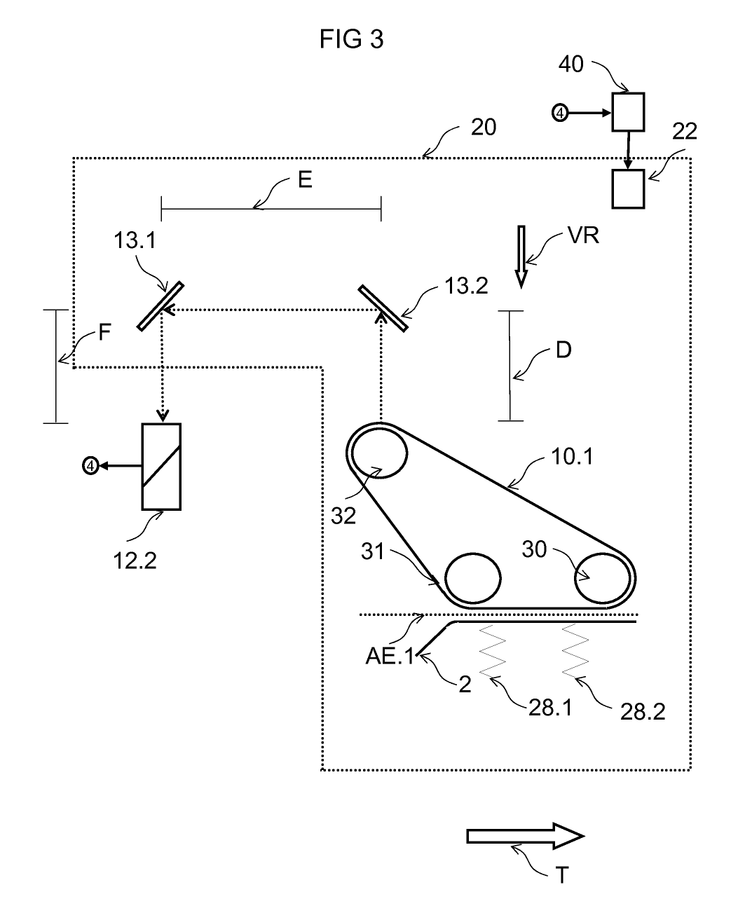

FIG. 3 shows one preferred embodiment which makes permanent measurement and simple regulation possible. In this embodiment, two passive reflectors 13.1, 13.2 are used. The constant spacing E occurs between the two passive reflectors 13.1, 13.2, and the spacing F occurs between the distance sensor 12.2 and the passive reflector 13.1. The spacing F changes if the mounting plate 20 is displaced. If the mounting plate 20 is displaced in the displacement direction VR, the spacing F is reduced. The spacing D which is increased by the wear of the driving conveyor belts of the first transport element 10.1 is produced between the passive reflector 13.2 and the surface of the first driving conveyor belt 10.1. The distance sensor 12.2 measures the overall spacing D+E+F. The distance sensor 12.2 preferably supplies a voltage value which depends on the measured spacing.

The distance sensor 12.2 is mounted in a stationary manner. The first transport element 10.1 and the two passive reflectors 13.1, 13.2 are mounted on the mounting plate 20 and can be displaced relative to the distance sensor 12.2 as a result. The wear of the first transport element 10.1 increases the spacing D. A displacement of the mounting plate 20 in the displacement direction VR brings it about that the spacing F is reduced. The mounting plate 20 is displaced in such a way that the overall spacing D+E+F remains constant. This brings it about that the displacement of the mounting plate 20 just compensates for the wear of the first transport element 10.1.

In contrast, the wear of the surface of the first retaining element 2 is preferably compensated for automatically by the first retaining conveyor belt 2 being pressed against the belt support 18.

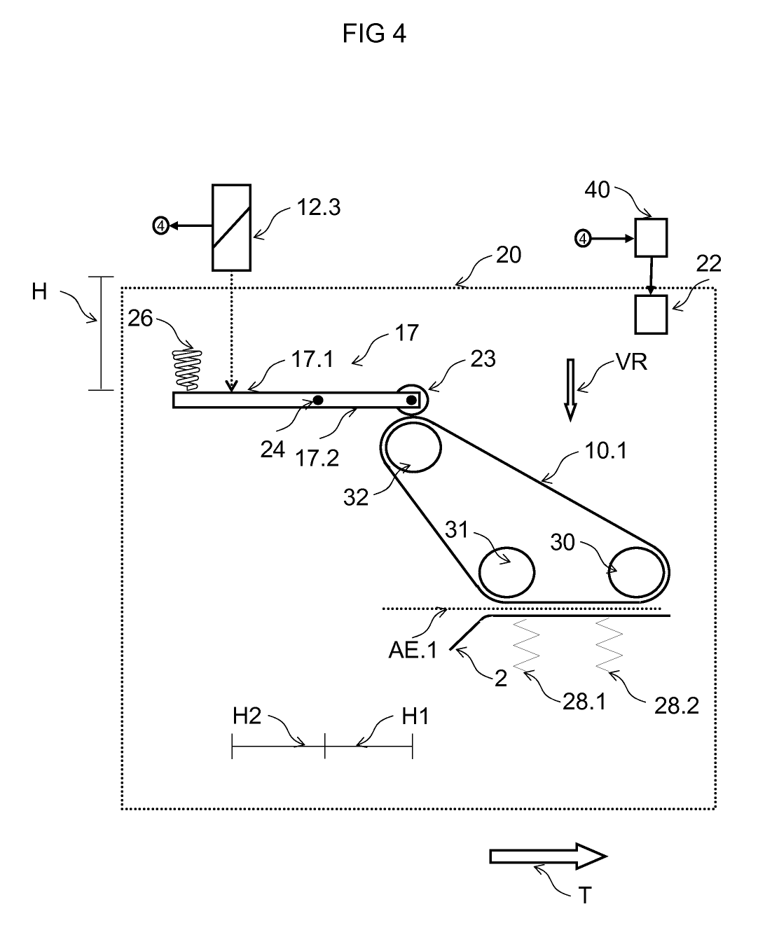

FIG. 4 shows a third refinement for monitoring and adjusting the first transport element 10.1. This refinement measures a spacing by means of at least one measurement lever 17. In this third refinement, at least one measurement lever 17 is pressed against the surface of a driving conveyor belt of the first transport element 10.1, to be precise in the region of the roller 32 and therefore in turn outside a region, in which a mail item is situated. It is possible that a plurality of measurement levers which are arranged above one another are pressed against in each case one driving conveyor belt.

A running roller 23 or a rotatably mounted ball 23 is in constant contact with the surface of the driving conveyor belt. For example, this constant contact is brought about by the measurement lever 17 being mounted rotatably on an axle 24 and a tension spring 26 pulling the free arm 17.1 of the measurement lever 17 to itself. The roller or ball 23 is seated at the end of the other arm 17.2 of the measurement lever 17. A distance sensor 12.3 measures the spacing H between itself and a point of the free arm 17.1 of the measurement lever 17. A reflecting foil or a similar element can be mounted on a surface of the free arm 17.1 of the measurement lever 17, which simplifies the distance measurement. The distance sensor 12.3 is mounted in a stationary manner, with the result that the first transport element 10.1 which is mounted on the mounting plate 20 can be displaced relative to the distance sensor 12.3. The surface of the transport element 10.1 can therefore be optimized for the separation by extension, and the surface of the measurement lever 17 can be optimized for the measurement of the section length.

The wear of a driving conveyor belt of the first transport element 10.1 brings it about that the measurement lever 17 is rotated about the axle 24 and the spacing H between the free arm 17.1 and the distance sensor 12.3 changes as a result. In the example of FIG. 4, the measurement lever 17 is rotated in the clockwise direction by the wear, and the measured spacing H is reduced. The reduction of the spacing H is proportional to the wear of said driving conveyor belt of the first transport element 10.1. The proportionality factor H1:H2 can be fixed by suitable positioning of the sensor 12.2 relative to the free arm 17.1. Here, H1 is the spacing between the contact point of the running roller 23 with the first transport element 10.1 and the shaft 24. H2 is the spacing between the space point of the distance sensor 12.3 and the shaft 24.

It is preferable that H1=H2, with the result that simple regulation is made possible. The mounting plate 20 is displaced in the displacement direction VR in such a way that the measured spacing H always remains the same.

In the embodiment which has just been described, the first transport element 10.1 is mounted onto a displaceable mounting plate 20, and the first retaining element 2 is mounted in a stationary manner. This refinement has the advantage that a mail item which is transported by the transport element and bears against the retaining element is always in contact with the advancing device in the gap between the two transport rollers 3.1, 3.2.

In an alternative embodiment, the first retaining element 2 is mounted on the displaceable mounting plate 20, and the first transport element 10.1 is mounted on a stationary base plate 19. In this alternative embodiment, the wear of the first transport element 10.1 is also measured, to be precise as described above with a distance sensor 12.1, 12.2, 12.3. The regulator 40 actuates the actuating drive 22, and the actuating drive 22 displaces the mounting plate 20 with the first retaining element 2 in such a way that the spacing between the first retaining element 2 and the first transport element 10.1 is reduced. In this way, the wear of the first transport element 10.1 is also compensated for.

The refinement of mounting the stationary retaining element 2 onto the displaceable mounting plate 20 makes a mechanically simple construction possible, because no driven parts are mounted on the mounting plate 20. However, the advancing element 3 has to be adjusted, or a mail item will not enter the gap between the two transport rollers 3.1, 3.2 precisely.

The following table provides a list of the reference numerals and reference characters used in the description and in the drawing figures:

| | |
|---|---|
| 2 | First retaining element, belongs to the first separator |
| 3 | Advancing element with the transport rollers 3.1, 3.2 |
| 3.1, 3.2 | Transport rollers at the end of the first separator |
| 4 | Light barrier arrangement, acts as overlap detection device |
| 4.1 | Transmitter line of the light barrier arrangement 4 of the |
| | second separator |
| 4.2 | Receiver line of the light barrier arrangement 4 of the second |
| | separator |
| 5 | Control device |
| 7 | Second retaining element, belongs to the second separator |
| 7.1 | Diverting element of the second retaining element 7 |
| 8.1, 8.2 | Transport rollers at the end of the second separator |
| 9 | Drive motor for the second driving conveyor belt 10.2 |
| 10.1 | First transport element, belongs to the first separator and |
| | has a plurality of driving conveyor belts |
| 10.2 | Second transport element, belongs to the second separator |
| | and has a plurality of driving conveyor belts |
| 11.1 | Receiver of the light barrier of the second separator |
| 11.2 | Receiver of the light barrier of the second separator |
| 12.1 | Distance sensor, directly measures the wear of the first driving |
| | conveyor belt 10.1 |
| 12.2 | Distance sensor, indirectly measures the wear of the first |
| | driving conveyor belt 10.1 by measurement of D + E + F |
| 12.3 | Distance sensor, measures the deflection of the measurement |
| | lever 17 |
| 13.1, 13.2 | Passive reflectors |
| 14.1 | Receiver of the light barrier of the first separator |
| 14.2 | Receiver of the light barrier of the first separator |
| 15 | Drive motor for the transport rollers 3.1, 3.2 |
| 16 | Drive motor for the first driving conveyor belt 10.1, rotates |
| | the roller 32 |
| 17 | Measurement lever |
| 17.1 | Free arm of the measurement lever 17 |
| 17.2 | Arm of the measurement lever 17 with the running roller 23 |
| 18 | Belt support of the first retaining conveyor belt 2 |
| 19 | Base plate, on which the first retaining element 2 is mounted |
| 20 | Mounting plate, on which the first driving conveyor belt |
| | 10.1 is mounted |
| 21 | Spindles between the actuating drive 22 and the mounting |
| | plate 20 |
| 22 | Actuating drive for rotating the spindles 21 |
| 23 | Ball or running roller on the arm 17.2 of the measurement |
| | lever 17 |
| 24 | Axle, on which the measurement lever 17 is mounted |
| | rotatably |
| 26 | Tension spring which acts on the free arm 17.1 |
| 27 | Rake of the belt support 18 |
| 28.1, 28.2 | Compression springs which press the first retaining element 2 |
| | toward the first driving conveyor belt 10.1 |
| 29.1, 29.2 | Compression springs which press the second retaining element |
| | 7 toward the second driving conveyor belt 10.2 |
| 30, 31 | Running rollers, around which the first driving conveyor belt |
| | 10.1 is guided |
| 32 | Driven roller, around which the first driving conveyor belt |
| | 10.1 is guided |
| 33 | Drive motor for the transport rollers 8.1, 8.2 |
| 40 | Regulator, actuates the actuating drive 22 |
| 50 | Intake chamber of the first separator |
| 51 | Intake chamber of the second separator |
| AE.1 | Extending plane of the first separator |
| AE.2 | Extending plane of the second separator |
| B | Spacing D between the surface of the first driving conveyor |
| | belt 10.1 and the distance sensor 12.1 |
| C | Spacing, by which the first driving conveyor belt 10.1 |
| | protrudes out of the rake 27 |
| D | Spacing D between the surface of the first driving conveyor |
| | belt 10.1 and the passive reflector 13.2 |
| E | Spacing between the two passive reflectors 13.1 and 13.2 |
| F | Spacing between the distance sensor 12.2 and the passive |
| | reflector 13.1 |
| H | Spacing between the distance sensor 12.3 and the free |
| | arm 17.1 of the measurement lever 17 |
| H1 | Spacing between the contact point of the running roller 23 |
| | with the first transport element 10.1 and the shaft 24 |
| H2 | Spacing between the space point of the distance sensor |
| | 12.3 and the shaft 24 |
| T | Transport direction, in which the two separators transport |
| | mail items |
| V | Spacing between the extending planes of the first separator |
| | and of the second separator |
| VR | Displacement direction, in which the actuating drive 22 |
| | displaces the mounting plate 20 |

1. An apparatus for separating flat objects, each of the objects extending in an object plane, the apparatus comprising:
a first separator having a driving element and a retaining element; and
a second separator having a driving element and a retaining element;
said first and second separators being connected in series and each object first running through said first separator and then through said second separator, wherein each object is transported through between the respective said driving element and the respective said retaining element of each said first and second separator, and
each of said first and second separators being configured:
to move the respective said driving element relative to the respective said retaining element; and
to pull apart a plurality of objects that overlap one another at least partially in a respective extending plane parallel to the object planes, and to thereby singulate the plurality of objects;
wherein the two extending planes are perpendicular to a horizontal; and
said first and second separators being disposed with a lateral offset therebetween, resulting in a spacing distance between the two extending planes.

2. The apparatus according to claim 1, wherein said second separator comprises a stationary deflection element disposed to deflect an object from the extending plane of said first separator into the extending plane of said second separator, when the object is transported from said first separator to said second separator.

3. The apparatus according to claim 1, wherein said second separator comprises an endless conveyor belt disposed to deflect an object from the extending plane of said first separator into the extending plane of said second separator, when the object is transported from said first separator to said second separator.

4. The apparatus according to claim 1, wherein each object to be separated is transported on a transport path extending through between said driving elements and said retaining elements, and wherein said transport element of said first separator is disposed on a different side of said transport path than said transport element of said second separator.

5. The apparatus according to claim 1, wherein each of said first a second separators includes one advancing element, and said first and second separators are disposed such that a flat object
is first of all transported through between said driving element and said retaining element of said first separator;
subsequently reaches said advancing element of said first separator;
is then transported through between said driving element and said retaining element of said second separator; and
subsequently reaches said advancing element of said second separator.

6. The apparatus according to claim 1, wherein said first and second separators are disposed such that the extending plane of said first separator lies parallel to the extending plane of said second separator.

7. The apparatus according to claim 1, wherein said first and second separators are disposed such that the extending plane of said first separator and the extending plane of said second separator adjoin one another at an acute angle.

8. The apparatus according to claim 7, wherein the extending planes abut one another along a straight line, and the straight line stands perpendicularly on the horizontal.

9. The apparatus according to claim 7, wherein the extending planes abut one another along a straight line, and the straight line extends horizontally.
